(19) United States
(12) Patent Application Publication
(10) Pub. No.: US 2023/0364611 A1
(43) Pub. Date: Nov. 16, 2023

(54) DEVICE FOR SEQUENTIAL POSITIONING OF PARTICLES

(71) Applicant: EVORION Biotechnologies GmbH, Münster (DE)

(72) Inventors: Hans Kleine-Brüggeney, Münster (DE); Robert Weingarten, Münster (DE); Sebastian Bühren, Nottuln (DE)

(21) Appl. No.: 18/007,436

(22) PCT Filed: Jul. 30, 2021
(86) PCT No.: PCT/EP2021/071395

§ 371 Date: Jul. 10, 2023

(30) Foreign Application Priority Data
Jul. 31, 2020 (DE) 10 2020 004 660.6

(51) Int. Cl. B01L 3/00

(52) U.S. Cl. CPC B01L 3/502761; B01L 2200/0647; B01L 2400/0463; B01L 2200/027

(57) ABSTRACT

The invention relates to a device, which is preferably microfabricated, comprising a positioning device for the sequential positioning of particles, wherein the positioning device has a preferably rigid delimiting structure, wherein the delimiting structure forms a first receptacle (3) for positioning a particle and a second receptacle (4) for positioning a particle, wherein the first receptacle (3) and the second receptacle (4) are arranged in a row, wherein the positioning device comprises a device opening (5) through which fluid can flow into the positioning device, wherein the positioning device comprises a device channel extending from the device opening (5) into the positioning device, wherein the device channel comprises the first receptacle (5) and the second receptacle (5), wherein the device (1) comprises at least one bypass channel (6, 7), wherein the device (1) comprises a branching point (8), wherein the device channel and the bypass channel (6, 7) are branched via the branching point (8) in such a way that a flow particle located in the branching point (8) can flow into the bypass channel (6, 7) or via the device opening (5) into the device channel.

The device channel has a greater hydrodynamic resistance than the bypass channel (6, 7). Alternatively, the device channel has the same hydrodynamic resistance as the bypass channel (6, 7).

The invention relates to a microfabricated device with a positioning device for the sequential positioning of particles. The positioning device has a preferably rigid delimiting structure, wherein the delimiting structure forms a first receptacle for positioning a particle and a second receptacle for positioning a particle. The first receptacle and the second receptacle are arranged in a row, wherein the positioning device has a device opening through which the fluid can flow into the positioning device. The positioning device comprises a device channel extending from the device opening into the positioning device, the device channel comprising the first receptacle and the second receptacle. The device has at least one bypass channel. The device comprises a branching point, wherein the device channel and the bypass channel are branched via the branching point in such a way that a flow particle that is located in the branching point can flow into the bypass channel or via the device opening into the device channel.

Such a device is known from international application WO 2019 048 713 A1. As can be seen in FIG. 27.2 D of the international application, the device contains a device channel which comprises three receptacles for the sequential positioning of particles, and two bypass channels. As can be taken from pages 29 and 30 of the description, each of the three receptacles is first occupied by a particle before a fourth particle can flow into the bypass channel to the next device. This is due to the channels having a higher hydrodynamic resistance compared to the device channel. This is also the case when even two of the three receptacles of the device channel are each occupied by a particle. The higher hydrodynamic resistance of the bypass channels is due to their much greater length compared to the device channel.

The known device is disadvantageous in that a particle flowing into the device inevitably flows into the device channel and that a particle only flows into the bypass channel if all receptacles are already occupied by particles. However, this is not desired for every application.

The problem to be solved by the invention is therefore to further develop the known device in such a way that a selection can be made as to whether a particle flows into the device channel or into the bypass channel.

The problem is solved by the device according to claim 1. The problem is also solved by the system and the methods according to the other independent claims. Advantageous embodiments are disclosed in the respective dependent claims, the description and the figures.

The solution is achieved in that the device channel has a greater hydrodynamic resistance than the bypass channel. Since particles follow the path of least resistance in a flow, the particles flow into the bypass channel if no intervention into the system takes place. An intervention may occur by giving the particle in the flow a certain momentum needed for the particle to flow into the device channel instead of into the bypass channel. The particle can be given a higher momentum by specifically increasing the flow rate. For example, the flow rate can be increased when the particle is located in the branching point of the channels.

In an alternative embodiment, the device channel has the same hydrodynamic resistance as the bypass channel.

Preferably, the device channel is designed in such a way that fluid flowing in through the device opening can flow out of the device channel at the end of the device channel (channel end) opposite the device opening. For this purpose, the device channel has at least one opening at the channel end. In this case, a sufficiently large particle can be held in the second receptacle, while the fluid can flow out through the opening at the channel end at the same time. Moreover, the opening at the channel end has the advantage that, when the flow is reversed, a particle that is located in the second receptacle can be conveyed out of the second receptacle into the first receptacle or a particle that is located in the first receptacle can be conveyed out of the first receptacle through the device opening.

Preferably, the first (second) receptacle is wider than the first opening and than the second opening. Thus, an elastic particle larger than the first and second openings can be compressed while passing through the first opening and can be expanded after passing through the first opening. As a result, the particle can be positioned securely in the first receptacle. The same applies to the passage through the second opening and the positioning in the second receptacle.

The first receptacle is different from the second receptacle. Preferably, the device is designed in such a way that a particle that leaves the first receptacle directly passes into the second receptacle. The receptacles are thus preferably directly adjacent.

The device preferably comprises a second bypass channel, wherein the device channel, the first bypass channel and the second bypass channel are branched via the branching point in such a way that a flow particle that is located in the branching point can flow into the first bypass channel, into the second bypass channel or via the device opening into the device channel. In this case, the device channel has a greater hydrodynamic resistance than the first bypass channel and than the second bypass channel. Alternatively, the device channel, the first bypass channel and the second bypass channel have the same hydrodynamic resistance.

The term “device channel” is a synonym for “positioning device channel.” The term “device opening” is a synonym for “positioning device opening.” These terms are preferred due to their shorter form and the associated improvement in readability.

In a preferred embodiment, the device channel also has a greater hydrodynamic resistance than the bypass channel when the first receptacle or the second receptacle is occupied. This also applies when one of the two receptacles is completely occupied, i.e., the receiving space is completely filled, in particular with a particle.

The condition that the device channel has a greater hydrodynamic resistance than the bypass channel or that the device channel has the same hydrodynamic resistance as the bypass channel in particular applies when particles are neither in the device channel nor in the bypass channel. The ratio of the hydrodynamic resistances is therefore due to the (empty) structure of the device, even if there may be applications in which the hydrodynamic resistance of the bypass channel may temporarily exceed that of the device channel, for example because a particle that is approximately as large as the cross section of the bypass channel flows through the bypass channel.

In a preferred embodiment, the device is designed in such a way that a particle that flows via the branching point into the bypass channel and flows further in the bypass channel along the longitudinal axis of the bypass channel cannot pass into the device channel. This embodiment is in particular suitable for the applications in which a particle is to flow into either the bypass channel or the device channel.

In an exemplary embodiment, the device is designed in such a way that no connection exists between the bypass channel and the device channel except for the branching point. A particle thus cannot flow from the bypass channel into the device channel, or vice versa, irrespective of its size, the flow path and the flow rate (with the exception of the path across the branching point). This can be realized, for example, by the side wall of the device channel being closed.

In a preferred embodiment, the bypass channel is shorter than, the same length as or at most twice as long as the device channel. An advantage of the invention is that the bypass channel is significantly smaller than the bypass channel of the known device. The length of the channels is the main factor for adjusting the hydrodynamic resistance. For this purpose, the cross section of the channel is suitable to a limited extent only, since it must fulfill the requirement of allowing a particle of a given diameter to pass through. In contrast to the known device, that relies on a long bypass channel to adjust the required hydrodynamic resistance, the bypass channel according to the invention may even be smaller than the device channel. A glance at FIG. 27.2 D of WO 2019 048 713 A1 already illustrates that the device according to the present invention results in enormous space savings in comparison to the known device.

In a preferred embodiment, the delimiting structure has a first delimiting section, wherein the first delimiting section forms a first opening so that a particle can pass through the first opening into the first receptacle. Additionally or alternatively, the delimiting structure has a second delimiting section, wherein the second delimiting section forms a second opening so that a particle can pass through the second opening into the second receptacle. The first opening is preferably the device opening.

Preferably, the device is designed in such a way that a particle passes from the first receptacle directly into the second receptacle when the particle passes through the second opening into the second receptacle. The receptacles are thus directly adjacent. This embodiment is suitable for applications in which two particles, each located in a receptacle, should touch.

In a preferred embodiment, the first delimiting section and the second delimiting section form the first receptacle, wherein the positioning device has a third delimiting section. The second delimiting section and the third delimiting section form the second receptacle.

In a preferred embodiment, the first delimiting section comprises two separate section parts, wherein the section parts define the first opening. Additionally or alternatively, the second delimiting section comprises two separate section parts, wherein the section parts define the second opening. The third delimiting section is preferably in one piece. Preferably, the third section is located on the longitudinal axis of the device channel and does not extend over the entire cross section of the device channel. As a result, fluid flowing into the device channel via the device opening can leave the device channel on the side of the device channel opposite the device opening.

In a preferred embodiment, the delimiting sections are spaced apart along an axis, wherein the second delimiting section is arranged between the first delimiting section and the third delimiting section.

In a preferred embodiment, the positioning device is mirror-symmetrical to a plane, wherein the plane extends through the first opening and the second opening and preferably does not intersect the section parts of the first delimiting structure and the section parts of the second delimiting structure, wherein the plane preferably intersects the third delimiting structure.

In a preferred embodiment, the delimiting structure is designed in such a way that a rigid spherical object, which is preferably located completely in the first receptacle, is prevented from moving in the direction of the first opening and from moving in the direction of the second opening if the object has such a large diameter that it can pass neither through the first opening nor through the second opening, and contacts the first delimiting section and the second delimiting section, and/or wherein the delimiting structure is designed in such a way that a rigid spherical object, which is preferably located completely in the second receptacle, is prevented from moving in the direction of the second opening and from moving in the opposite direction when the object has such a large diameter that it can pass neither through the first opening nor through the second opening, and contacts the second delimiting section and the third delimiting section. This embodiment provides the advantage that spherical particles in particular can be positioned securely in the first and second receptacles.

In a preferred embodiment, the device comprises a first particle and a second particle. In this case, the first particle is positioned in the first receptacle and the second particle is positioned in the second receptacle, wherein the particles preferably touch one another, wherein the first and second particles preferably comprise a hydrogel, wherein preferably, the first particle includes one or more types of binding molecules, such as antibodies or aptamers, and the second particle includes one or more biological cells, viruses or cellular components.

Furthermore, the invention relates to a system comprising a first device according to the invention and at least one second device according to the invention, wherein the first device and the second device are connected via a connecting channel in such a way that a particle that flows at the branching point of the first device into the bypass channel can pass via the connecting channel into the branching point of the second device. Preferably, the system comprises a plurality of devices according to the invention. Since the device according to the invention already ensures enormous space savings compared to the prior art, this applies especially to the system. The system according to the invention makes it possible to treat and analyze a significantly higher number of particles. As a result, the productivity of biotechnological processes can be significantly increased.

In a preferred embodiment, the connecting channel has an inlet section, wherein the inlet section is connected to the branching point of the second device. Preferably, the inlet section and the device channel of the second device are coaxial, or the axis of the inlet section and the axis of the device channel form an angle of −45° to 45°. Due to this arrangement, a smaller momentum is required to move a particle into the device channel.

In a preferred embodiment, the connecting channel has at least one extension section. The extension section is preferably serpentiform. Preferably, the extension section extends transversely or obliquely to the axis of the device channel of the first device and of the device channel of the second axis, which are, in particular, preferably coaxial. In this way, a dense arrangement of the devices is maintained while simultaneously lengthening the flow path of the particles from one device to the other. For certain applications, a longer flow path and a longer flow duration of the particles are required or advantageous.

The invention furthermore relates to a method for the sequential positioning of particles in a device according to the invention, the method comprising the following steps: moving a first particle into the first receptacle so that the first particle is positioned in the first receptacle, wherein the first particle passes through the first opening; moving the first particle into the second receptacle so that the first particle is positioned in the second receptacle, wherein the first particle passes through the second opening; moving a second particle into the first receptacle so that the second particle is positioned in the first receptacle, wherein the second particle passes through the first opening. Preferably, the particles touch one another while they are in the respective receptacle. Alternatively, they may also be spaced apart, preferably having a minimum distance from one another of at most 20, 40 or 60 μm.

Preferably, the particles are of different particle types. The first particle is thus a particle of a first particle type and the second particle is a particle of a second particle type. Within the meaning of the invention, “particle type” refers to a type of particle defined by the characteristic of one or more features. A feature may, for example, be the composition of the particle. A particle type differs from another if the characteristics of at least one feature are different.

The particle may, for example, include cells or biological molecules (for example, antibodies).

Preferably, biological cells are contained in a particle of the first particle type (for example, enclosed therein). Additionally or alternatively, binding molecules (for example antibodies) are contained in a particle of a second particle type.

Preferably, the positioning device can receive at most two particles, namely the first and the second particle.

In a preferred embodiment, the method further comprises the following step: moving the second particle through the first opening so that the second particle leaves the first receptacle.

In a preferred embodiment, the method furthermore comprises the following steps: moving the first particle into the first receptacle so that the first particle is positioned in the first receptacle, wherein the first particle passes through the second opening; moving the first particle through the first opening so that the first particle leaves the first receptacle.

In a preferred embodiment, the movement of the first or the second particle into the first receptacle (wherein the first or second particle passes through the first opening) takes place by increasing the momentum of the particle when the particle is at the branching point, wherein the momentum is increased in such a way that the momentum reaches a threshold value, wherein the particle flows into the bypass channel when the threshold value is not reached.

In a preferred embodiment, the first particle is elastic and larger than both the first and the second opening. Additionally or alternatively, the second particle is elastic and larger than both the first and the second opening. The elasticity allows the respective particle to be squeezed through the respective opening, whereas a corresponding rigid particle could not pass through the opening. After passing through the opening, the particle is preferably again in a non-deformed state. Preferably, the particles have the same elasticity and/or the same mass and/or the same size. Alternatively, the particles have different elasticities and/or different masses and/or different sizes.

In a preferred embodiment, the movement of a particle is caused by the flow of a fluid in which the particle is located, wherein the particle velocity is adjusted by adjusting the flow rate so that the particle is given a momentum in order to pass through the relevant opening, wherein the flow rate is preferably the only manipulated variable.

The invention also relates to a method for the sequential positioning of particles in a system according to the invention, the method comprising the following steps: moving a first particle into the first receptacle of the first device so that the first particle is positioned in the first receptacle, wherein the first particle passes through the first opening of the first device; moving a second particle into the first receptacle of the second device so that the second particle is positioned in the first receptacle, wherein the second particle passes through the first opening of the second device.

Preferably, the first particle and the second particle are of the same particle type.

In a preferred embodiment, the method furthermore comprises the following steps: moving the first particle into the second receptacle of the first device so that the first particle is positioned in the second receptacle, wherein the first particle passes through the second opening; moving the second particle into the second receptacle of the second device so that the second particle is positioned in the second receptacle, wherein the second particle passes through the second opening.

In a preferred embodiment, the method further comprises the following step: rinsing the positioning device of the first device and the positioning device of the second device with a fluid that contains a bead population of a first type.

In a preferred embodiment, the method further comprises the following steps: moving a third particle into the first receptacle of the first device so that the third particle is positioned in the first receptacle, wherein the third particle passes through the first opening of the first device; moving a fourth particle into the first receptacle of the second device so that the fourth particle is positioned in the first receptacle, wherein the fourth particle passes through the first opening of the second device; rinsing the positioning device of the first device and the positioning device of the second device with a fluid that contains a bead population of a second type.

Preferably, the third particle and the fourth particle are of the same particle type. Particularly preferably, their particle type differs from that of the first and second particles.

The invention furthermore relates to a use of the device according to the invention for carrying out the method according to the invention for the sequential positioning of particles in a device according to the invention. Furthermore, the invention relates to a use of the system according to the invention for carrying out the method according to the invention for the sequential positioning of particles in a system according to the invention.

Exemplary embodiments are described with reference to the figures below. Shown are:

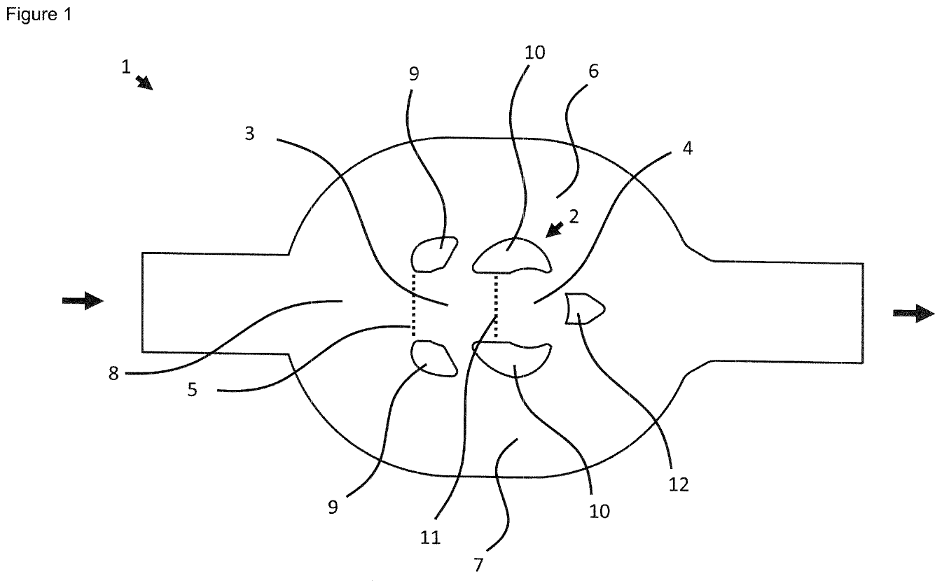

FIG. 1 an embodiment of a device according to the invention,

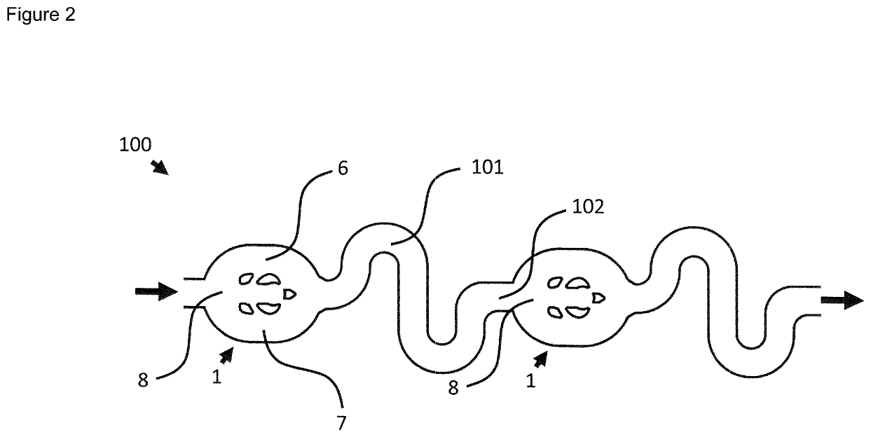

FIG. 2 an embodiment of a system according to the invention,

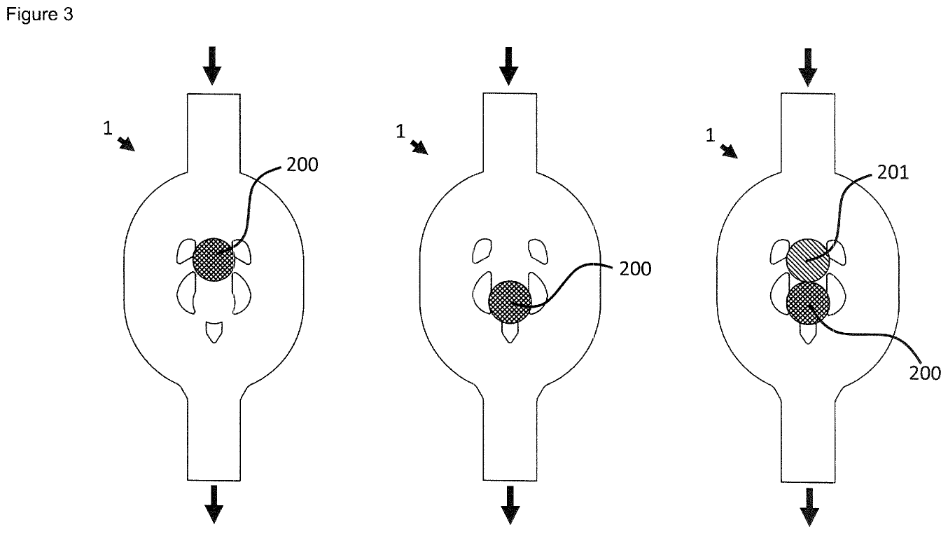

FIG. 3 a possible sequence for the positioning of particles.

FIG. 1 shows an embodiment of a device 1 according to the invention with a positioning device 2 for the sequential positioning of particles. The positioning device 2 has a rigid delimiting structure. The delimiting structure forms a first receptacle 3 for positioning a particle and a second receptacle 4 for positioning a particle. The first receptacle 3 and the second receptacle 4 are arranged in a row. The positioning device comprises a device opening 5 through which fluid can flow into the positioning device 2. The positioning device 2 comprises a device channel extending from the device opening 5 into the positioning device 2, the device channel comprising the first receptacle 3 and the second receptacle 4. The device 1 comprises a first bypass channel 6 and a second bypass channel 7. The device comprises a branching point 8, wherein the device channel, the first bypass channel 6 and the second bypass channel 7 are branched via the branching point 8 in such a way that a flow particle that is located in the branching point 8 can flow into the first bypass channel 6, into the second bypass channel 7 or via the device opening 5 into the device channel. The device channel has a greater hydrodynamic resistance than the first bypass channel 6 and than the second bypass channel 7.

The delimiting structure comprises a first delimiting section 9, wherein the first delimiting section forms a first opening 5 so that a particle can pass through the first opening 5 into the first receptacle 3. Additionally, the delimiting structure comprises a second delimiting section 10, wherein the second delimiting section 10 forms a second opening 11 so that a particle can pass through the second opening 11 into the second receptacle 4. In the present case, the first opening 5 is identical to the device opening 5.

The first delimiting section 9 and the second delimiting section 10 form the first receptacle 3, wherein the positioning device has a third delimiting section 12. The second delimiting section 10 and the third delimiting section 12 form the second receptacle 4.

The first delimiting section 9 comprises two separate section parts, wherein the section parts define the first opening 5. Additionally, the second delimiting section 10 comprises two separate section parts, wherein the section parts define the second opening 11. The third delimiting section 12 is in one piece.

FIG. 2 shows an embodiment of a system 100 according to the invention comprising a first device 1 according to the invention and a second device 1 according to the invention. In this case, the first device 1 and the second device 1 are connected via a connecting channel 101 in such a way that a particle that flows at the branching point 8 of the first device into one of the two bypass channels 6 or 7 can pass via the connecting channel into the branching point 8 of the second device 1.

The connecting channel 101 has an inlet section 102, wherein the inlet section 102 is connected to the branching point 8 of the second device 1. The straight inlet section 102 and the device channel of the second device are coaxial. The connecting channel 101 has a serpentiform extension section.

FIG. 3 shows a possible sequence for the positioning of particles in a device according to the invention. The left partial figure shows the device with a first particle 200 positioned in the first receptacle 3. The particle 200 is elastic and is spherical in the non-deformed state. It is larger than the first opening 5. By means of the flow, the particle 200 was given a sufficiently large momentum so that it could pass through the first opening 5. The middle partial figure shows the first particle 200 in the second receptacle 4. In this case, the momentum of the particle 200 was increased by means of the flow so that it could pass through the second opening 11. The right partial figure shows a second particle 201 positioned in the first receptacle 3. The second particle 201 is elastic and is spherical in the non-deformed state. It is larger than the first opening 5. By means of the flow, the momentum of the second particle 201 was increased so that it could pass through the first opening 5.

1. Device (1), which is preferably microfabricated, comprising a positioning device for the sequential positioning of particles, wherein the positioning device has a preferably rigid delimiting structure, wherein the delimiting structure forms a first receptacle (3) for positioning a particle and a second receptacle (4) for positioning a particle, wherein the first receptacle (3) and the second receptacle (4) are arranged in a row, wherein the positioning device comprises a device opening (5) through which fluid can flow into the positioning device, wherein the positioning device comprises a device channel extending from the device opening (5) into the positioning device, wherein the device channel comprises the first receptacle (5) and the second receptacle (5), wherein the device (1) comprises at least one bypass channel (6, 7), wherein the device (1) comprises a branching point (8), wherein the device channel and the bypass channel (6, 7) are branched via the branching point (8) in such a way that a flow particle located in the branching point (8) can flow into the bypass channel (6, 7) or via the device opening (5) into the device channel, characterized in that the device channel has a greater hydrodynamic resistance than the bypass channel (6, 7) or that the device channel has the same hydrodynamic resistance as the bypass channel (6, 7).

2. Device (1) according to the preceding claim, wherein the device (1) is designed in such a way that a particle that flows via the branching point (8) into the bypass channel (6, 7) and flows further in the bypass channel (6, 7) along the longitudinal axis of the bypass channel (6, 7) cannot pass into the device channel.

3. Device (1) according to one of the preceding claims, wherein the bypass channel (6, 7) is shorter than, the same length as or at most twice as long as the device channel.

4. Device (1) according to one of the preceding claims, wherein the delimiting structure has a first delimiting section (9), wherein the first delimiting section (9) forms a first opening (5) so that a particle can pass through the first opening (5) into the first receptacle (3), and/or the delimiting structure has a second delimiting section (10), wherein the second delimiting section (10) forms a second opening (11) so that a particle can pass through the second opening (11) into the second receptacle (3), wherein the first opening (5) is preferably the device opening (5), wherein the device (1) is preferably designed in such a way that a particle passes from the first receptacle directly into the second receptacle when the particle passes through the second opening (11) into the second receptacle (3).

5. Device (1) according to the preceding claim, wherein the first delimiting section (9) and the second delimiting section (10) form the first receptacle (3), wherein the positioning device has a third delimiting section (12), wherein the second delimiting section (10) and the third delimiting section (12) form the second receptacle (4).

6. Device (1) according to one of claim 4 or 5, wherein the first delimiting section (9) comprises two separate section parts, wherein the section parts define the first opening (5), and/or wherein the second delimiting section (10) comprises two separate section parts, wherein the section parts define the second opening (11).

7. Device (1) according to one of claims 4 to 6, wherein the delimiting sections are spaced apart along an axis, wherein the second delimiting section (10) is arranged between the first delimiting section (9) and the third delimiting section (12).

8. Device (1) according to one of the preceding claims, wherein the positioning device is mirror-symmetrical to a plane, wherein the plane extends through the first opening (5) and the second opening (11) and preferably does not intersect the section parts of the first delimiting structure (9) and the section parts of the second delimiting structure (10), wherein the plane preferably intersects the third delimiting structure (12).

9. Device (1) according to one of claims 5 to 8, wherein the delimiting structure is designed in such a way that a rigid spherical object, which is preferably located completely in the first receptacle (3), is prevented from moving in the direction of the first opening (5) and from moving in the direction of the second opening (11) when the object has such a large diameter that it can pass neither through the first opening (5) nor through the second opening (11), and contacts the first delimiting section and the second delimiting section, and/or wherein the delimiting structure is designed in such a way that a rigid spherical object, which is preferably located completely in the second receptacle (4), is prevented from moving in the direction of the second opening (11) and from moving in the opposite direction when the object has such a large diameter that it can pass neither through the first opening (3) nor through the second opening (11), and contacts the second delimiting section and the third delimiting section.

10. Device (1) according to one of claims 1 to 8, wherein the device (1) comprises a first particle (200) and a second particle (201), wherein the first particle (200) is positioned in the first receptacle (3), wherein the second particle (201) is positioned in the second receptacle (4), wherein the particles preferably touch, wherein the first and second particles preferably comprise a hydrogel, wherein preferably, the first particle includes one or more types of binding molecules, such as antibodies or aptamers, and the second particle includes one or more biological cells, viruses or cellular components.

11. System (100) comprising a first device (1) according to one of the preceding claims and a second device (1) according to one of the preceding claims, wherein the first device (1) and the second device (1) are connected via a connecting channel in such a way that a particle that flows at the branching point (8) of the first device into the bypass channel (6, 7) can pass via the connecting channel (101) into the branching point (8) of the second device (1).

12. System (100) according to the preceding claim, wherein the connecting channel (101) comprises an inlet section (102), wherein the inlet section (102) is connected to the branching point (8) of the second device (1).

13. System (100) according to one of the preceding system claims, wherein the connecting channel (101) comprises a preferably serpentiform extension section.

14. Method for the sequential positioning of particles in a device (1) according to one of claims 1 to 10, the method comprising the following steps: moving a first particle into the first receptacle (3) so that the first particle is positioned in the first receptacle (3), wherein the first particle passes through the first opening (5); moving the first particle into the second receptacle (10) so that the first particle is positioned in the second receptacle (4), wherein the first particle passes through the second opening (11); moving a second particle into the first receptacle (3) so that the second particle is positioned in the first receptacle (3), wherein the second particle passes through the first opening (5).

15. Method according to the preceding claim, the method furthermore comprising the following step: moving the second particle through the first opening (5) so that the second particle leaves the first receptacle (3).

16. Method according to the preceding claim, the method furthermore comprising the following steps: moving the first particle into the first receptacle (3) so that the first particle is positioned in the first receptacle (3), wherein the first particle passes through the second opening (11); moving the first particle through the first opening (5) so that the first particle leaves the first receptacle (3).

17. Method according to one of the preceding method claims, wherein the movement of the first or the second particle into the first receptacle (3), wherein the first or the second particle passes through the first opening (5), takes place by increasing the momentum of the particle when the particle is at the branching point (8), wherein the momentum is increased in such a way that the momentum reaches a threshold value, wherein the particle flows into the bypass channel (6, 7) when the threshold value is not reached.

18. Method according to one of the preceding method claims, wherein the first particle is elastic and is larger than the first opening (5) and than the second opening (11) and/or the second particle is elastic and is larger than the first opening and than the second opening.

19. Method according to one of the preceding method claims, wherein the movement of a particle is caused by the flow of a fluid in which the particle is located, wherein the particle velocity is adjusted by adjusting the flow rate so that the particle is given a momentum in order to pass through the relevant opening, wherein the flow rate is preferably the only manipulated variable.

20. Method for the sequential positioning of particles in a system (100) according to one of the previous system claims, the method comprising the following steps: moving a first particle into the first receptacle (3) of the first device so that the first particle is positioned in the first receptacle (3), wherein the first particle passes through the first opening (5) of the first device; moving a second particle into the first receptacle (3) of the second device so that the second particle is positioned in the first receptacle (3), wherein the second particle passes through the first opening (5) of the second device.

21. Method according to the preceding claim, the method furthermore comprising the following steps: moving the first particle into the second receptacle (4) of the first device so that the first particle is positioned in the second receptacle (4), wherein the first particle passes through the second opening (11); moving the second particle into the second receptacle (4) of the second device so that the second particle is positioned in the second receptacle (4), wherein the second particle passes through the second opening (11).

22. Method according to one of the two preceding claims, the method furthermore comprising the following steps: rinsing the positioning device of the first device and the positioning device of the second device with a fluid that contains a bead population of a first type.

23. Method according to one of the two preceding claims, the method furthermore comprising the following steps: moving a third particle into the first receptacle (3) of the first device so that the third particle is positioned in the first receptacle (3), wherein the third particle passes through the first opening (5) of the first device; moving a fourth particle into the first receptacle (3) of the second device so that the fourth particle is positioned in the first receptacle (3), wherein the fourth particle passes through the first opening (5) of the second device; rinsing the positioning device of the first device and the positioning device of the second device with a fluid that contains a bead population of a second type.

24. Use of the device according to one of the preceding claims 1 to 10 for carrying out the method according to one of claims 14 to 19 or use of the system according to one of the system claims for carrying out the method according to one of claims 20 to 23.
